(19) United States
(12) Patent Application Publication
(10) Pub. No.: US 2004/0206709 A1
(43) Pub. Date: Oct. 21, 2004

(54) Dehydrating press for a sludge

(76) Inventors: Reindert Buisman, Gauteng (ZA); Werner Hartmut Altmann, Tobelmuehle Bishoffzell (CH)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 10/479,264

(22) PCT Filed: May 31, 2002
(86) PCT No.: PCT/ZA02/00095

(30) Foreign Application Priority Data
May 31, 2001 (ZA) 2001/4486

(51) Int. Cl. C02F 1/00

(52) U.S. Cl. 210/783

(57) ABSTRACT

A dehydration apparatus (10) for a sludge comprises an endless first metal screen (14) having a first section (14.1) and a second section (14.2). Material to be dehydrated is introduced onto section (14.1) at inlet (18). A liquid collection region (70) is located between the first and second sections. The liquid collection region comprises a liquid suction chamber connected to a compressed air driven venturi (78) for generating suction in the chamber. The apparatus further comprises a press having a compression region (22) formed by converging sections (14.1) and (16.1). Vibrators (28.1), hot air introducing boxes and liquid suction boxes (30.1) adjacent the compression region aid in the dewatering process. Dehydrated cakes are delivered between rollers (13) and (17).

### TECHNICAL FIELD

THIS invention relates to solid and liquid separating apparatus and more particularly to dehydration filters, and filter presses.

Separating apparatus in the form of filter presses for removing liquids from a sludge are known in the art. The known filter presses suffer from one or the other disadvantage. For example, some filter presses comprise cooperating moving endless screens, made of a synthetic material, to press the liquid from the sludge. Each of the screens is fed about a plurality of rollers and idlers and has positive and negative bends therein. These opposite bends limit the operational life of the screens. Furthermore, the screens are often hydrophilic, which reduces the drainage through the screens. Still furthermore, the known screens, in use, become stretched and strands are flattened out, which reduce the open areas of the screens and hence the drainage and dehydrating capability thereof. Still furthermore, many of the known apparatus cannot accommodate heating stages and/or coarser solid particles.

In WO 90/13347 there is disclosed a separation device comprising an endless metal filtering belt which in use is driven to follow a closed trajectory. Suction is generated by a fan to draw a liquid through the belt. The device is bulky maintenance intensive and unnecessarily expensive.

### OBJECT OF THE PRESENT INVENTION

Accordingly it is an object of the present invention to provide apparatus with which the applicant believes the aforementioned disadvantages may at least be alleviated.

### SUMMARY OF THE INVENTION

According to the invention there is provided filter apparatus comprising:

an endless first metal screen having a first section and a second section;

a liquid collection region located between the first and second sections;

the liquid collection region comprising a liquid suction chamber connected to a compressed air driven device for generating suction in the chamber.

The metal is preferably stainless steel.

The screen may comprise a plurality of parallel weft elements in the form of stainless steel rods and a plurality of parallel warp elements in the form of stranded stainless steel cables.

The screen may in use move along a closed trajectory about longitudinally spaced first and second end rollers, so that the first section extends linearly between the first roller and the second roller and the second section is a return run.

The second roller may be driven by suitable drive means such as an electric motor, to cause the screen to move.

An inlet for matter to be filtered may be provided onto the first section in a region thereof towards the first roller.

The inlet may comprise an arrangement for distributing the matter evenly onto the first section. The arrangement may comprise a first plate slanting in a first direction and a second plate slanting in a transverse direction and defining a transversely extending opening onto the first section between the first plate and the second plate. The first and second plates may be housed in an inlet box and the box may comprise a trailing blade extending transversely to the first section.

The liquid collection region may comprise a sump defining the liquid suction chamber and the sump may comprise a top wall defining a plurality of holes to admit liquid.

Sidewalls of the sump may slant towards an outlet and the compressed air driven device may be provided downstream from the outlet.

The device may comprise one of a venturi and a compressed air ventilator.

The apparatus may further comprise a press for the matter.

The press is preferably located downstream from said liquid collection region and towards the second roller.

The press preferably comprises a second endless screen providing a compression zone between the second screen and the first section of the first screen.

The second screen is preferably made of metal such as stainless steel and is mounted in use to move along a closed trajectory about first and second longitudinally spaced rollers for the second screen, so that a first section extends linearly between the first and second rollers for the second screen and a return section extends between the second roller and the first roller.

The compression zone is preferably provided between the first section of the first screen and the first section of the second screen which converge towards one another in a direction towards the second rollers.

The first section of the first screen and the first section of the second screen may be guided in the compression zone by transversely extending roller pairs. A first roller of each pair may support the first section of the first screen in the compression zone and is preferably longitudinally offset relative to another roller in the pair.

At least one liquid collection region comprising a liquid suction chamber connected to a compressed air driven device for generating suction in the chamber is provided adjacent the compression zone.

A vibration generating system may also be provided adjacent the compression zone. The system may comprise a housing, a moveable member located in the housing, an inlet for compressed air into the housing and an outlet for the air from the housing into the zone. In other embodiments the means for generating vibrations may be electrically driven.

A reflector for vibrations may be provided on another side of the compression zone.

The compressed air is preferably heated to a temperature higher than 100° C.

Also included within the scope of the invention is a method of filtering a liquid from a mixture thereof with solids, the method comprising the steps of

utilizing a first metal screen to transmit the liquid and to stop the solids; and

utilizing suction generated by a compressed air driven device, to facilitate transmission of the liquid.

The mixture may also be fed through a compression zone formed between the first metal screen and a second metal screen.

### BRIEF DESCRIPTION OF THE ACCOMPANYING DIAGRAMS

The invention will now further be described, by way of example only, with reference to the accompanying diagrams wherein:

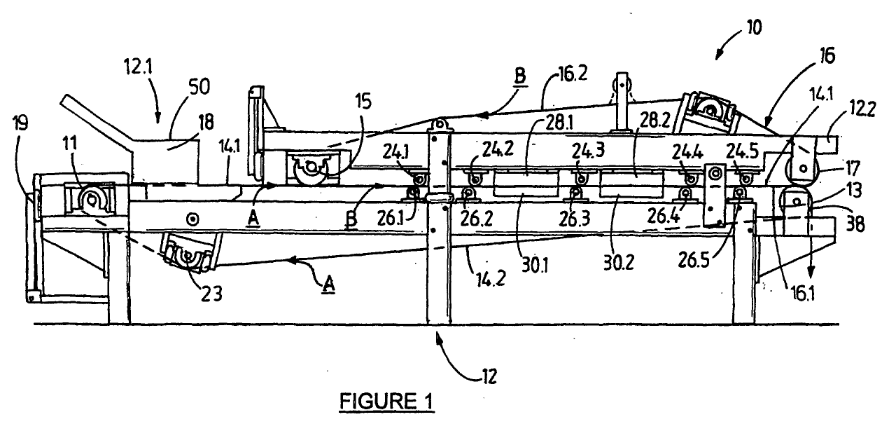

FIG. 1 is a diagrammatic side view of apparatus according to the invention;

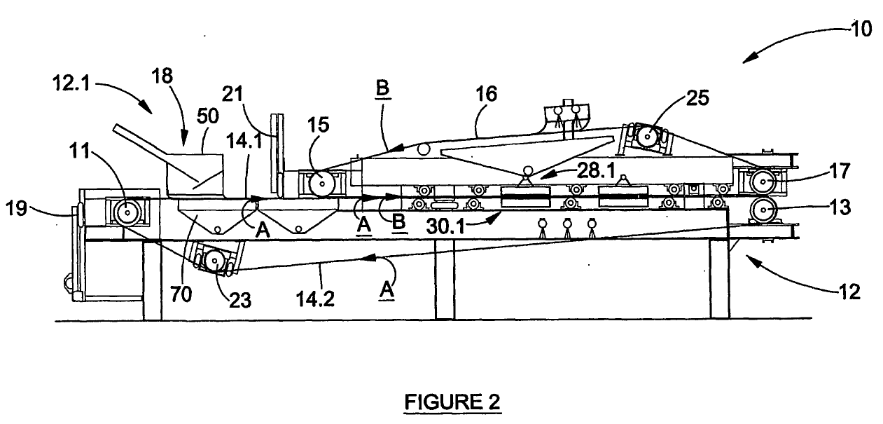

FIG. 2 is a longitudinal section through the apparatus in FIG. 1;

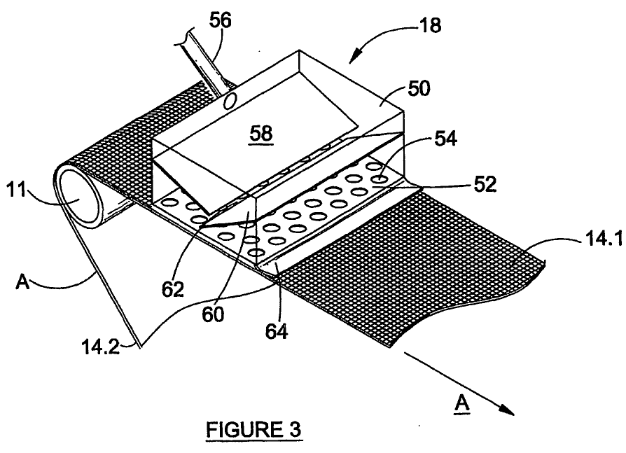

FIG. 3 is a diagrammatic perspective view of a mixture feed box forming part of the apparatus;

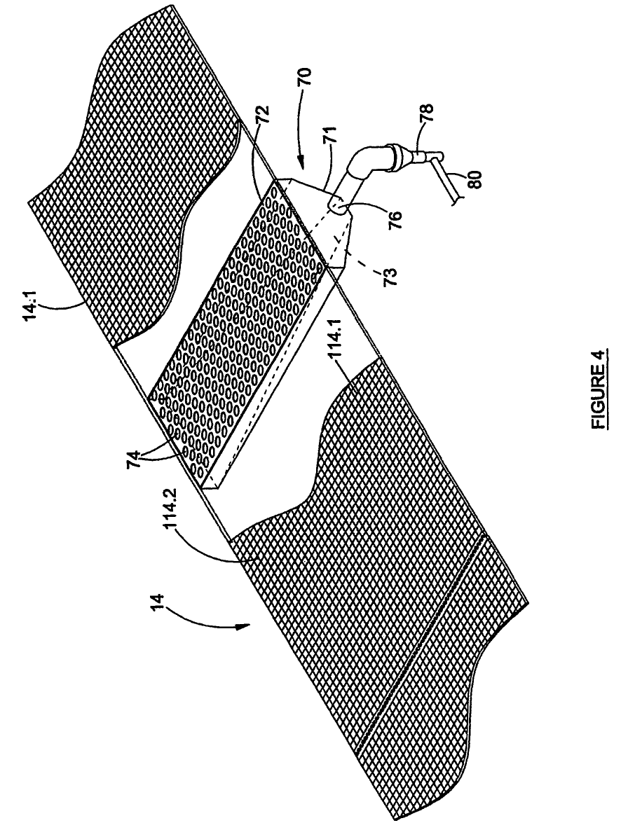

FIG. 4 is a diagrammatic perspective view of a screen and suction box forming part of the apparatus; and

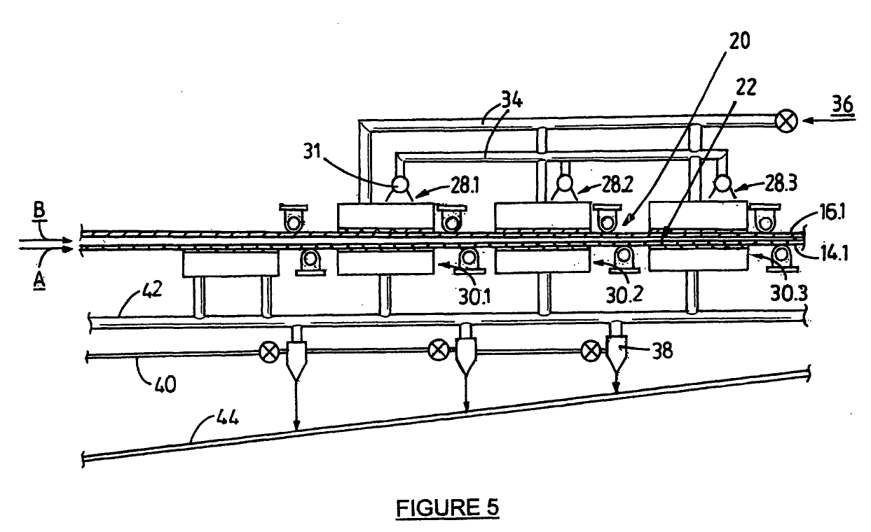

FIG. 5 is a schematic diagram of a compression zone of the apparatus.

### DESCRIPTION OF A PREFERRED EMBODIMENT OF THE INVENTION

A filter press for a sludge (such as sewage), slurry, paper pulp, coal, iron ore and the like is generally designated by the numeral 10 in FIGS. 1 and 2.

The filter 10 comprises an elongate frame 12 supporting in a bottom region thereof a first or bottom endless screen 14 extending about longitudinally spaced first and second end rollers 11 and 13. The frame further supports in a top region thereof a second or upper endless screen 16 extending about longitudinally spaced first and second end rollers 15 and 17.

Adjacent each of first end rollers 11 and 15 there are provided pneumatically operated screen tensioning mechanisms 19 and 21. Furthermore, screen 14 also extends past pneumatically operable screen tracking mechanism 23 and screen 16 extends past a similar screen tracking mechanism 25. The tensioning and tracking mechanisms cooperate with one another to accommodate the screens.

Each screen is made of stainless steel and in use, is driven to follow a closed trajectory. Screen 14 follows closed trajectory A in a clockwise direction and screen 16 follows closed trajectory B in an anti-clockwise direction. Screen 14 has a linear first section or top run 14.1 extending from roller 11 to roller 13 and a return run 14.2. Screen 16 has a linear first section or bottom run 16.1 extending from roller 15 to roller 17 and a return run 16.2. As is shown in FIGS. 1 and 2, the screens are bent in one direction only, in that rollers and idlers about which the screens are bent are all located on the inside of the respective trajectories. The screens are driven by suitable electric motors (not shown) driving second end rollers 13 and 17 respectively. Each screen comprises a plurality of parallel weft members 114.1 in the form of stainless steel rods and a plurality of parallel warp elements 114.2 in the form of stranded stainless steel cables.

As shown in FIG. 1, towards one end 12.1 of frame 12, first screen 14 extends beyond screen 16. An inlet onto screen 14 for matter to be dehydrated, is provided at 18. The inlet is shown in more detail in FIG. 3 and comprises a box 50 having a floor 52 of a synthetic plastic material defining holes 54. An inlet duct 56 communicates with the box and transversely extending plates 58, 60 in the box define a transversely extending slot 62 between them. A flexible blade 64 of rubber or the like distributes the material evenly onto section 14.1 of screen 14.

As shown in FIG. 2, between first section or top run 14.1 of screen 14 and second section or return run 14.2 there is provided a suction box 70, shown in more detail in FIG. 4.

The sidewalls 71 and bottom 73 of box 70 are made of stainless steel. A top 72 is made of a synthetic plastic material and defines a plurality of holes 74. The sidewalls and bottom slope towards an outlet 76. Apart from the holes 74, the box is substantially airtight. As shown in FIG. 2, the top 72 overlaps at least partially with floor 52 of inlet box 50.

The outlet 76 is connected to a compressed air driven device such as a venturi 78 or ventilator (not shown) to generate suction inside the box 70.

The compressed air is provided via duct 80.

As shown in FIG. 5, in region 20 of frame 12, screen 14 and screen 16 converge towards one another in the direction of other end 12.2 of the frame, to define a wedge shaped compression zone 22, between bottom run 16.1 of upper screen 16 and top run 14.1 of bottom screen 14.

As best shown in FIGS. 1 and 2, transversely extending elongate rollers 24.1 to 24.5 guiding the bottom run of upper screen 16 in region 20 are slightly off-set in a longitudinal direction of the frame from corresponding rollers 26.1 to 26.5 supporting the top run of bottom screen 14. In a preferred embodiment and as shown in FIG. 5, first or upper roller 24.1 of a roller pair 24.1, 26.1 leads the other roller 26.1 of the pair.

As shown in FIGS. 1 and 2, above section 16.1 of screen 16 adjacent region 20 and between adjacent pairs of off-set rollers, such as pair 24.2, 26.2 and pair 24.3, 26.3 there are provided low frequency vibration generating arrangements 28.1 and 28.2. Also between adjacent roller pairs, but below section 14.1 of screen 14 there are provided low pressure or suction arrangements 30.1 and 30.2, substantially similar to the arrangement 70 hereinbefore described.

Referring to FIG. 5, each vibration generating arrangement comprises a compressed air vibrator 31 and a box 32. Each vibrator 31 is connected via a conduit system 34 to a source 36 of hot (between 100° C. and 150° C.) and compressed air. The hot air is utilized to agitate a ball (not shown) in a housing of the vibrator 31. The air moves through the vibrator and holes in a floor of box 32 to be ejected into the wedge shaped compression zone 22 via the holes. Below top run 14.1 of mesh 14 and opposite boxes 32, there may be provided reflectors (not shown) to reflect upwardly and back towards wedge shaped zone 22 incident vibrations generated by the arrangements 28.1 to 28.3.

The suction arrangements 30.1 to 30.3 are connected to a venturi system 38 to produce low pressure or liquid suction regions below top run 14.1 of screen 14 and preferably immediately downstream of each pair of off-set rollers. The venturi system is also connected to the source 36 of compressed air by duct 40, to utilize the compressed air, to generate the low pressure or suction regions. The sumps of arrangements 30.1 to 30.3 may be connected via a manifold 42 to system 38. A drain for the water filtered out is shown at 44.

In use, sludge to be dehydrated is received on section 14.1 of screen 14 of the apparatus in region 18. Initial dehydration is performed by the screen 14.1 and liquid suction box 70. The sludge is then fed by screen 14 into the wedge shaped zone 22. In the wedge shaped zone, the sludge is sandwiched between the converging bottom screen 14 and upper screen 16. Liquid is now pressed out of the sludge by the cooperating screens. The dewatering is aided by the vibrations generated adjacent zone 22. Furthermore, the hot air ejected into the zone 22 further assists in the dewatering action and the suction arrangements 30.1 to 30.3 still further assists in removing liquid from the sludge. Dehydrated cakes are recovered at 38 at end 12.2 of frame 12.

1. Filter apparatus comprising:
an endless first metal screen having a first section and a second section;
a liquid collection region located between the first and second sections;
the liquid collection region comprising a liquid suction chamber connected to a compressed air driven device for generating suction in the chamber.

2. Apparatus as claimed in claim 1 wherein the metal is stainless steel.

3. Apparatus as claimed in claim 1 wherein the screen comprises a plurality of parallel weft elements in the form of stainless steel rods and a plurality of parallel warp elements in the form of stranded stainless steel cables.

4. Apparatus as claimed in claim 1 wherein the screen in use moves along a closed trajectory about longitudinally spaced first and second end rollers, so that the first section extends linearly from the first roller to the second roller and the second section is a return run.

5. Apparatus as claimed in claim 4 wherein the second roller is driven to cause the screen to move.

6. Apparatus as claimed in claim 4 wherein an inlet for matter to be filtered is provided onto the first section in a region thereof towards the first roller.

7. Apparatus as claimed in claim 6 wherein the inlet comprises an arrangement for distributing the matter evenly onto the first section.

8. Apparatus as claimed in claim 7 wherein the arrangement comprises a first plate slanting in a first direction and a second plate slanting in a transverse direction and defining a transversely extending opening onto the first section between the first plate and the second plate.

9. Apparatus as claimed in claim 8 wherein the first and second plates are housed in an inlet box and wherein the box comprises a trailing blade extending transversely to the first section.

10. Apparatus as claimed in claim 1, wherein the liquid collection region comprises a sump defining the liquid suction chamber, the sump comprising defining the liquid suction chamber, the sump comprising a top wall defining a plurality of holes to admit liquid.

11. Apparatus as claimed in claim 10 wherein sidewalls of the sump slant towards and outlet.

12. Apparatus as claimed in claim 11 wherein the compressed air driven device is provided downstream from the outlet.

13. Apparatus as claimed in claim 1, wherein the device comprises one of a venturi and a compressed air ventilator.

14. Apparatus as claimed in claim 1, comprising a press.

15. Apparatus as claimed in claim 14 wherein the press is located downstream from said liquid collection region and towards the second roller.

16. Apparatus as claimed in claim 14 wherein the press comprises a second endless screen providing a compression zone between the second screen and the first screen.

17. Apparatus as claimed in claim 16 wherein the second screen is made of stainless steel and is mounted in use to move along a closed trajectory about longitudinally spaced first and second rollers fro the second screen, so that a first section extends linearly from the first roller to the second roller for the second screen and a return section extends from the second roller to the first roller.

18. Apparatus as claimed in claim 17 wherein the compression zone is provided between the first section of the first screen and the first section of the second screen which converge towards one another in a direction towards the second rollers.

19. Apparatus as claimed in claim 18 wherein the first section of the first screen and the first section of the second screen are guided in the compression zone by transversely extending roller pairs.

20. Apparatus as claimed in claim 19 wherein a first roller of each pair supports the first section of the first screen in the compression zone and is longitudinally offset relative to another roller in the pair guiding the first section of the second screen.

21. Apparatus as claimed in claim 1, wherein at least one liquid collection region comprising a liquid suction chamber connected to a compressed air driven device for generating suction in the chamber is provided adjacent the compression zone.

22. Apparatus as claimed in claim 1, wherein a vibration generating system is provided adjacent the compression zone, the system comprising a housing, a moveable member located in the housing, an inlet for compressed air into the housing and an outlet for the air from the housing into the zone.

23. Apparatus as claimed in claim 22 comprising a reflector for vibrations located on another side of the compression zone.

24. Apparatus as claimed in claim 22 wherein the compressed air is heated to a temperature higher than 100° C.

25. A method of filtering a liquid from a mixture thereof with solids, the method comprising the steps of
utilizing a first metal screen to transmit the liquid and to stop the solids; and
utilizing suction generated by a compressed air driven device, to facilitate transmission of the liquid.

26. A method as claimed in claim 25 wherein the mixture is fed through a compression zone formed between the first metal screen and a second metal screen.
